(19) United States
(12) Patent Application Publication
(10) Pub. No.: US 2010/0283381 A1
(43) Pub. Date: Nov. 11, 2010

(54) Phosphor and light emitting device

(75) Inventors: Kohsei Takahashi, Kobe-shi (JP); Naoto Hirosaki, Tsukuba-shi (JP)

Correspondence Address: MORRISON & FOERSTER LLP, 1650 TYSONS BOULEVARD, SUITE 400, MCLEAN, VA, 22102, US

(73) Assignees: SHARP KABUSHIKI KAISHA; NATIONAL INSTITUTE FOR MATERIALS SCIENCE

(21) Appl. No.: 11/517,421

(22) Filed: Sep. 6, 2006

(30) Foreign Application Priority Data
Sep. 6, 2005 (JP) 2005-258114 (P)
Jan. 4, 2006 (JP) 2006-000234 (P)
Aug. 10, 2006 (JP) 2006-217836 (P)

(51) Int. Cl. H01J 1/63; C09K 11/78

(52) U.S. Cl. 313/503; 252/301.4 R

(57) ABSTRACT

A JEM phase phosphor having superior luminous efficiency is obtained, and a light emitting device is provided, which includes first and second phosphors and in which fluorescence from the first phosphor is not much absorbed by the second phosphor, with the JEM phase phosphor used as a first phosphor. The first phosphor is the JEM phase phosphor having optical absorption of at most 30% at a wavelength in a relation of complementary color to the emission wavelength of the first phosphor. In the light emitting device having a combination of the first phosphor and the second phosphor emitting fluorescence of longer wavelength than the first phosphor, the first phosphor has optical absorption at the emission wavelength of the second phosphor of at most 30%.

This nonprovisional application is based on Japanese Patent Applications Nos. 2005-258114, 2006-000234 and 2006-217836 filed with the Japan Patent Office on Sep. 6, 2005, Jan. 4, 2006 and Aug. 10, 2006, respectively, the entire contents of which are hereby incorporated by reference.

### BACKGROUND OF THE INVENTION

1. Field of the Invention

The present invention relates to a phosphor, particularly an oxynitride phosphor, and to a light emitting device using the phosphor and a semiconductor light emitting element.

2. Description of the Background Art

A semiconductor light emitting device such as a light emitting diode (LED) has advantages of small size, low power consumption, and capability of stable emission of high luminance. A light emitting device providing visible light by combining a semiconductor light emitting element and a phosphor has the advantages of the semiconductor light emitting element and, in addition, emits light of a desired color such as white, in accordance with the intended use. Therefore, it may be used as a backlight source for a liquid crystal display, portable telephone or a portable information terminal, a display device used for indoor or outdoor advertisement, an indicator for various portable equipment, an illumination switch, a light source for OA (Office Automation) equipment or the like.

Japanese Patent Laying-Open No. 10-163535 discloses a light emitting device having a combination of a semiconductor light emitting element emitting blue or blue-violet light and one or two phosphors. Here, the phosphor is selected such that the color of light emitted by the semiconductor light emitting element and the color of light emitted by the phosphor are complementary to each other, so that quasi-white light is emitted as a result.

Japanese Patent Laying-Open No. 09-153644 discloses a dot-matrix type display device using group III nitride semiconductor emitting ultraviolet light having the peak emission wavelength of 380 nm as an excitation light source, and having three different phosphor layers respectively emitting three primary colors of red, green and blue.

Further, Japanese Patent Laying-Open No. 2002-171000 discloses a light emitting device using a semiconductor light emitting element emitting light having the wavelength of 390 nm to 420 nm and a phosphor excited by the light from the semiconductor light emitting element, and emitting white light. Here, the semiconductor light emitting element emits light of low visibility to human eyes, which leads to the advantage that even when emission intensity or emission wavelength of the semiconductor light emitting element varies, color tone hardly varies. Further, the light having the wavelength of 390 nm to 420 nm hardly causes any damage to device components such as resin in which the phosphor is dispersed, and has minor influence to human body.

Conventionally, an oxide or a sulfide has been widely used as phosphor material. Recently, examples of oxynitride or nitride phosphor have been disclosed in Japanese Patent Laying Open Nos. 2002-363554 and 2003-206481, a pamphlet of International Publication No. WO2005/019376, Naoto HIROSAKI, Rong-Jun XIE, Koji KIMOTO, Takashi SEKIGUCHI, Yoshinobu YAMAMOTO, Takayuki SUEHIRO, and Mamoru MITOMO, “Characterization and properties of green-emitting β-SiAlON: Eu²⁺ powder phosphors for white light-emitting diodes,” Applied Physics Letters 86, 211905 (2005) and in Kyota UEDA, Naoto HIROSAKI, Hajime YAMAMOTO and Rong-Jun XIE, “Red phosphors for warm white light-emitting diodes”, the 305th Meeting Technical Digest of Phosphor Research Society, 2004, pp. 37-47. These phosphors emit light with high efficiency when excited by light having the wavelength of 390 nm to 420 nm, and many of these have superior characteristics such as high chemical stability and high heat resistance, and small variation in luminous efficiency even when temperature of use varies.

Japanese Patent Laying-Open No. 2004-244560 discloses a light emitting device having the following structure. When excited by a light emitting element excited at the wavelength of 400 nm, a phosphor (Ca_{0.93}, Eu_{0.05}, Mn_{0.02})₁₀(PO₄)₆Cl₁₂ has peak emission wavelength in a blue-violet to blue region, a phosphor (Ca_{0.955}Ce_{0.045})₂(Si_{0.964}Al_{0.036})₅N₈ has peak emission wavelength in a blue-green to green region, and a phosphor SrCaSi₅N₈:Eu has peak emission wavelength in a yellow-red to red region. Mixing of colors from these phosphors result in light emission in white region.

Among the oxynitride phosphors, a JEM phase phosphor disclosed in the pamphlet of WO2005/019376 has been known as a silicon oxynitride phosphor having the JEM phase, which is a crystal phase different from α SiAlON or βSiAlONi, emitting blue light of conventionally unattained high intensity when excited by near ultraviolet ray.

Japanese Patent Laying-Open No. 2004-071357 discloses a prior art light emitting device that corresponds to one embodiment of the present invention, in which phosphors are arranged in the order of a semiconductor light emitting element, a red phosphor, a green phosphor and a blue phosphor, so that re-absorption of light emitted from the phosphor closer to the semiconductor element can be suppressed.

Further, Japanese Patent Laying-Open No. 2004-331934 discloses a red phosphor La₂O₂S:Eu⁺Si, having powder reflectance at red or shorter wavelength of 450 nm, 545 nm and 624 nm of at least 84%, 94% and 97%, respectively.

### SUMMARY OF THE INVENTION

A first object of the present invention is to attain satisfactory luminous efficiency in a JEM phase phosphor.

A second object of the present invention is to provide a light emitting device having a combination of a first phosphor and a second phosphor emitting light of longer wavelength than the first phosphor, in which the light emitted from the second phosphor is not much absorbed by the first phosphor, resulting in satisfactory luminous efficiency.

In the following, means for solving the problems in accordance with the present invention will be described. In order to clarify the reason why such means are used, some functions and effects associated with the means will also be described. The effects are collateral and not the essential solution of the problems and, therefore, the effects do not limit the scope of the invention.

The present invention provides a phosphor emitting fluorescence of a first wavelength, having optical absorption of at most 30% at a wavelength longer than the first wavelength and in a relation of complementary color to the first wavelength, and having JEM phase as a main crystal phase. The wavelength in a relation of complementary color to the first wavelength represents a wavelength that results in white when combined with the light of the first wavelength.

Preferably, the phosphor of the present invention is represented by a composition formula Mᵢ₋ₓ,CeₓAl(Si_{y1-z}Al_{z})N_{y2-z}O_{z}, where M represents at least one element selected from the group consisting of La, Pr, Nd, Sm, Eu, Gd, Tb, Dy, Ho, Er, Tm, Yb and Lu, x is a real number satisfying 0.1≦×≦1, y1 is a real number satisfying 5.9≦y1≦6.1, y2 is a real number satisfying 10.0≦y2≦10.7, and z is a real number satisfying 0.8≦z≦1.2 and more preferably 0.9≦z≦1.1.

The inventors have found that in the phosphor, optical absorption and luminous efficiency at a wavelength longer than the first wavelength of fluorescent emission and in a relation of complementary color to the first wavelength are correlated, and that when optical absorption at the wavelength of complementary color to the first wavelength is at most 30%, good luminous efficiency can be attained.

The present invention provides a light emitting device, including: a semiconductor light emitting element emitting excitation light; a first phosphor absorbing the excitation light and emitting fluorescence; and a second phosphor of one type or a plurality of types absorbing the excitation light and emitting fluorescence of a wavelength longer than the fluorescence emitted by the first phosphor; wherein the first phosphor has optical absorption (hereinafter also referred to as long wavelength optical absorption) of at most 30% at a peak emission wavelength of the fluorescence emitted by one main type of the second phosphor.

Preferably, in the light emitting device in accordance with the present invention, the above-described first phosphor has optical absorption of at most 30% at the wavelength longer than the first wavelength and in a relation of complementary color to the first wavelength, and has JEM phase as the main crystal phase.

Preferably, in the light emitting device in accordance with the present invention, the above-described first phosphor is represented by a composition formula M₁₋ₓCeₓAl(Si_{y1-z}Al_{z})N_{y2-z}O_{z}, where M represents at least one element selected from the group consisting of La, Pr, Nd, Sm, Eu, Gd, Tb, Dy, Ho, Er, Tm, Yb and Lu, x is a real number satisfying 0.1≦x≦1, y1 is a real number satisfying 5.9≦y1≦6.1, y2 is a real number satisfying 10.0≦y2h satisfying 5.9≦y1≦6.1, y2 is a real number satisfying 10.0≦y2 ≦10.7, and z is a ≦10.7, and z is a real number satisfying 0.8≦z≦1.2 and more preferably 0.9≦z≦1.1.

Preferably, in the light emitting device in accordance with the present invention, the first phosphor has peak emission wavelength of at least 450 nm and at most 510 nm.

Preferably, in the light emitting device in accordance with the present invention, the first phosphor has full width at half maximum of emission spectrum of at least 80 nm.

Preferably, in the light emitting device in accordance with the present invention, the light emitted from the first phosphor has chromaticity coordinate x of at least 0.05 and at most 0.25 and chromaticity coordinate y of at least 0.02 and at most 0.38.

Preferably, in the light emitting device in accordance with the present invention, one main type of the second phosphor has peak emission wavelength of at least 565 nm and at most 605 nm.

In the light emitting device in accordance with the present invention, by way of example, when the first phosphor emits fluorescence of blue or blue-green, a light emitting device emitting seemingly white light can be obtained by using a phosphor that emits light of complementary color thereto, that is, yellow light, as the second phosphor. Here, the one main type refers to one phosphor of which fluorescent emission intensity determined by the amount and luminous efficiency is higher than other phosphors, where a plurality of phosphors are used.

Preferably, in the light emitting device in accordance with the present invention, one main type of the second phosphor has full width at half maximum of emission spectrum of at least 80 nm.

Preferably, in the light emitting device in accordance with the present invention, the second phosphor includes an oxynitride phosphor.

Preferably, in the light emitting device in accordance with the present invention, the second phosphor includes an Eu activated α SiAlON phosphor.

Preferably, in the light emitting device in accordance with the present invention, the second phosphor includes an Eu activated α SiAlON containing Li.

Preferably, in the light emitting device in accordance with the present invention, the second phosphor includes an Eu activated α SiAlON represented by a composition formula Li_{0.87}Si₁₂₋ₘ₋ₙAlₘ₊ₙOₙN₁₆₋ₙ(1.5≦m≦2.5,n=0.5).

Preferably, in the light emitting device in accordance with the present invention, the second phosphor includes an Eu activated β SiAlON phosphor.

Preferably, in the light emitting device in accordance with the present invention, the second phosphor includes a nitride phosphor.

Preferably, in the light emitting device in accordance with the present invention, the second phosphor includes an Eu activated CaAlSiN₃.

Preferably, in the light emitting device in accordance with the present invention, the semiconductor light emitting element, a second member having the second phosphor dispersed, and a first member having the first phosphor dispersed are arranged in this order.

In the light emitting device in accordance with the present invention, the second member may further include a plurality of members, and the second phosphors of different types may be dispersed respectively in the plurality of members.

Preferably, in the light emitting device in accordance with the present invention, the excitation light has peak emission wavelength of at least 350 nm and at most 420 nm.

Preferably, in the light emitting device in accordance with the present invention, emission of the light emitting device has chromaticity coordinate x of at least 0.22 and at most 0.44 and chromaticity coordinate y of at least 0.22 and at most 0.44, or emission of the light emitting device has chromaticity coordinate x of at least 0.36 and at most 0.5 and chromaticity coordinate y of at least 0.33 and at most 0.46. When the light emitting device of the present invention provides light emission of the above-described chromaticity coordinates, light emission of white or incandescent lamp color can be attained, and therefore, the light emitting device is particularly suitable for illumination.

In the present invention, when the first phosphor is implemented by a JEM phase phosphor having low optical absorption in the wavelength region longer than the wavelength of fluorescence from the first phosphor, good luminous efficiency can be attained.

Further, in the present invention, when the light emitting device is adapted to have a combination of a second phosphor emitting light of longer wavelength than the first phosphor and the first phosphor having low optical absorption at the peak emission wavelength of the second phosphor, the luminous efficiency of the first phosphor is improved and the light emitted from the second phosphor is not much absorbed by the first phosphor, and as a result, a light emitting device having superior luminous efficiency as a whole device can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a result of measurement of excitation spectra of a JEM phase phosphor described in the preferred embodiment.

FIG. 2 shows a result of measurement of emission spectra of the JEM phase phosphor described in the preferred embodiment.

FIG. 3 shows a result of measurement of optical absorption spectra of the JEM phase phosphor described in the preferred embodiment.

FIG. 4 shows a relation between optical absorption and luminous efficiency of the JEM phase phosphor described in the preferred embodiment.

FIG. 5 shows a relation between the optical absorption of the JEM phase phosphor described in the preferred embodiment and luminous intensity of the light emitting device when the semiconductor light emitting element is driven with the driving current of 40 mA.

FIG. 6 is a cross sectional view of the light emitting device in accordance with Example 1.

FIG. 7 shows emission spectrum of the light emitting device in accordance with Example 1.

FIG. 8 shows emission spectrum of the light emitting device in accordance with Comparative Example 1.

FIG. 9 is a cross sectional view of the light emitting device in accordance with Example 2.

FIG. 10 shows emission spectrum of the light emitting device in accordance with Example 2.

FIG. 11 shows emission spectrum of the light emitting device in accordance with Comparative Example 3.

FIG. 12 shows emission spectrum of the light emitting device in accordance with Example 3.

FIG. 13 is a cross sectional view of the light emitting device in accordance with Example 4.

FIG. 14 shows emission spectrum of the light emitting device in accordance with Example 4.

FIG. 15 shows emission spectrum of the light emitting device in accordance with Example 5.

FIG. 16 is a cross sectional view of the light emitting device in accordance with Example 6.

FIG. 17 is a cross sectional view of the light emitting device in accordance with Example 7.

FIG. 18 shows excitation and emission spectra of Eu activated α SiAlON phosphor represented by composition formula Li_{0.87m}Si₁₂₋ₘ₋ₙAlₘ₊ₙOₙN₁₆₋ₙ(m=2.0, n=0.5 m

FIG. 19 shows emission spectrum of the light emitting device in accordance with Example 7.

FIG. 20 shows a relation between luminous efficiency of Eu activated α SiAlON phosphor represented by composition formula Li_{0.87m}Si₁₂₋ₘ₋ₙAlₘ₊ₙOₙN₁₆₋ₙ(m=2.0, n=0.5 m described in the preferred embodiment and the value m in the composition formula.

### DESCRIPTION OF THE PREFERRED EMBODIMENTS

The inventors closely studied the relation between luminous efficiency and optical absorption, and found that in a JEM phase phosphor, high luminous efficiency can be attained when the optical absorption is small. Possible reason for this is that when the optical absorption is small, the ratio of JEM phase is large and the ratio of glass phase is small.

Further, the inventors have found that, as regards the suitable nature of a phosphor when a plurality of phosphors are used in the light emitting device, not only superior luminous efficiency but also small optical absorption at other wavelength is important in order to improve the luminous efficiency of the light emitting device as a whole. Conventionally, Japanese Patent Laying-Open No. 2004-331934 includes a description that higher reflectance (having negative correlation with optical absorption) at a wavelength shorter than the fluorescence emitted from the phosphor is preferred. Generally, however, a phosphor absorbs light of shorter wavelength than the fluorescence and emits light, and therefore, it is obvious that optical absorption occurs at a region of shorter wavelength than that of fluorescence. The inventors have found that in a phosphor of blue to blue-green, particularly in a JEM phase phosphor, small optical absorption of light having longer wavelength than the fluorescence therefrom, specifically, low optical absorption of light of green to yellow to red having long wavelength, is actually important when the phosphor is used with other phosphor, particularly when it is used as a light emitting device.

Further, the inventors realized a light emitting device having superior color rendering property and providing white-based color (white, day white, incandescent lamp color and the like) suitable for illumination, using a JEM phase phosphor having superior light emission characteristics and suitable for combination with other phosphor or phosphors.

By way of example, in order to realize good color rendering property in a light emitting device using a semiconductor light emitting element emitting ultraviolet to violet light as an excitation source, a phosphor that emits light in a well-balanced manner over a wide wavelength range of visible light is necessary. For this purpose, it may be possible to mix a plurality of phosphors to attain high color rendering property. When the types of phosphors to be mixed increase, however, emission intensity as a whole decreases because of re-absorption of fluorescence. Considering this problem, utilizing the fact that the JEM phase phosphor having superior emission characteristic from blue to blue-green has wide full width at half maximum of emission spectrum, the JEM phase phosphor is combined with a phosphor to mutually complement wavelength in visible range, particularly, it is combined with a yellow phosphor, whereby a light emitting device having very high color rendering property and emits natural light can be obtained. Further, by mixing other phosphor, a light emitting device of higher color rendering property can be realized.

In the following, embodiments of JEM phase phosphor that absorbs light of ultraviolet to violet and emits light of blue to blue-green and other phosphors will be described, and embodiments of light emitting devices emitting white-based light using a combination of blue to blue-green phosphor and other phosphor emitting visible light will be described.

(JEM Phase Phosphor)

The phosphor in accordance with the present invention emits fluorescence of a first wavelength, and has optical absorption at a wavelength longer than the first wavelength and having a relation of complementary color to the first wavelength made low. As the optical absorption at a wavelength longer than the first wavelength is made low, superior luminous efficiency can be attained even when the phosphor is used with other phosphor or phosphors in a light emitting device.

The optical absorption at the wavelength longer than the first wavelength and of complementary color to the first wavelength is set to be at most 30%. Then, the optical absorption is sufficiently low, and therefore, good luminous efficiency can be attained when the phosphor is used in a light emitting device. The optical absorption of at most 20% is more preferred, and at most 15% is further preferred. The optical absorption is calculated by finding peak emission wavelength for the first wavelength and the wavelength of the color complementary to the first wavelength.

The main crystal phase of the phosphor in accordance with the present invention is JEM phase. As the main crystal phase is the JEM phase, the phosphor of the present invention provides satisfactory fluorescence of blue to blue-green. Further, the JEM phase phosphor has wide full width at half maximum of emission spectrum, and is advantageous when used for a light emitting device in combination with another phosphor, particularly a phosphor providing fluorescence of complementary color to the wavelength of light emitted from the JEM phase phosphor, as very high color rendering property and natural emission can be attained. Specifically, white light can be obtained simply by using another phosphor just to compensate for a deviation from white.

That the main crystal phase is JEM phase means the JEM phase occupies 50% or more in the crystal phase of the phosphor. The ratio can be calculated, by way of example, from intensity ratio of diffraction peak obtained through X-ray diffraction measurements.

In the present invention, the wavelength having a relation of complementary color to the first wavelength means the wavelength that provides white light when combined with the light of the first wavelength. Here, “white light” refers to the light of which chromaticity coordinate x is at least 0.22 and at most 0.44 and chromaticity coordinate y is at least 0.22 and at most 0.44. Therefore, the wavelength having the relation of complementary color to the first wavelength is obtained as a certain wavelength range and, in the present invention, optical absorption through the wavelength range is set to at most 30%.

In the present embodiment, JEM phase is defined as a substance having specific atom occupation sites (atom arrangement structures) as shown in Table 1 and crystal structure (Pbcn space group) characterized by the coordinates thereof. Details of the JEM phase are also described in Jekabs Grins et. al., “Preparation and Crystal Structure of LaAl(Si_{6-z}Al_{z})N_{10-z}O_{z}”, Journal of Materials Chemistry Vol. 5, November 1995, pp. 2001-2006.

TABLE 1

| | atom | site | coordinate (x) | coordinate (y) | coordinate (z) |
|---|---|---|---|---|---|
| (1) | RE | 8d | 0.0553 | 0.0961 | 0.1824 |
| (2) | Al | 4c | 0 | 0.427 | 0.25 |
| (3) | M(1) | 8d | 0.434 | 0.185 | 0.057 |
| (4) | M(2) | 8d | 0.27 | 0.082 | 0.52 |
| (5) | M(3) | 8d | 0.293 | 0.333 | 0.337 |
| (6) | X(1) | 8d | 0.344 | 0.32 | 0.14 |
| (7) | X(2) | 8d | 0.383 | 0.21 | 0.438 |
| (8) | X(3) | 8d | 0.34 | 0.485 | 0.41 |
| (9) | X(4) | 8d | 0.11 | 0.314 | 0.363 |
| (10) | X(5) | 8d | 0.119 | 0.523 | 0.127 |

space group: Pbcn

In Table 1, indications of “site” represent symmetry of space group. Coordinates x, y and z represent position of an element in respective lattices, and assume a value from 0 to 1. As to the column of “atom”, in the cell “RE”, M (at least one element selected from the group consisting of La, Pr, Nd, Sm, Eu, Gd, Tb, Dy, Ho, Er, Tm, Yb and Lu) and Ce will be input with the probability of respective composition ratio (1-x and x); in “Al”, Al only is input; in “M(1)” to “M(3)”, Si and Al are input with the probability of respective composition ratio (6-z and z); and in “X(1)” to “X(5)”, N and O are input with the probability of respective composition ratio (10-z and z). By comparing the X-ray diffraction data calculated using the values of Table 1 with the result of X-ray diffraction obtained by measurement of actual materials, whether the obtained material has JEM phase or not can be identified.

Preferably, the phosphor in accordance with the present invention is represented by the composition formula M₁₋ₓCeₓAl(Si_{y1-z}Al_{z})N_{y2-z}O_{z}. Here, M represents at least one element selected from the group consisting of La, Pr, Nd, Sm, Eu, Gd, Tb, Dy, Ho, Er, Tm, Yb and Lu, x is a real number satisfying 0.1 ≦×≦1, Y1 is a real number satisfying 5.9≦y1≦6.1, y2 is a real number satisfying 10.0≦y2 ≦10.7, and z is a real number satisfying 0.8≦Z≦1.2 and further, 0.9≦z≦1.1.

The phosphor in accordance with the present invention represented by the composition formula above is advantageous in that it has high content of JEM phase and hence has high luminous efficiency.

In the composition formula above, as the value x representing the amount of Ce activation increases, emission intensity tends to be higher, and considering high emission intensity, appropriate value of x is at least 0.1 and at most 1.

In the composition formula above, in an ideal JEM phase, it is expected that y1 and y2 assume about 6 and about 10, respectively. Actually, however, glass phase or other crystal phase is mixed, and therefore, preferably, Y1 is at least 5.9 and at most 6.1, and y2 is at least 10.0 and at most 10.7.

In the composition formula above, when the value z is at least 0.8 and at most 1.2 and preferably at least 0.9 and at most 1.1, the JEM phase can be obtained relatively easily, and hence such range is advantageous.

The present invention is also directed to a light emitting device, including: a semiconductor light emitting element emitting excitation light; a first phosphor absorbing the excitation light and emitting fluorescence; and a second phosphor of one type or a plurality of types absorbing the excitation light and emitting fluorescence of a wavelength longer than the fluorescence emitted by the first phosphor; wherein the first phosphor has optical absorption of at most 30% at a peak emission wavelength of the fluorescence emitted by one main type of the second phosphor.

In the light emitting device of the present invention, the first phosphor and the second phosphor are used in combination, and optical absorption of the fluorescence emitted by the second phosphor by the first phosphor is suppressed low. Therefore, a light emitting device having superior luminous efficiency can be obtained. When optical absorption is at most 30%, luminous efficiency sufficient for a light emitting device can be attained.

In the light emitting device of the present invention, preferably, the first phosphor mentioned above is a phosphor having the JEM phase as the main crystal phase, and by such a phosphor, a light emitting device having particularly superior luminous efficiency can be obtained.

Further, preferably, the first phosphor emits fluorescence of a first wavelength, has optical absorption at a wavelength longer than the first wavelength and in a relation of complementary color to the first wavelength of at most 30%, and has JEM phase as its main crystal phase. In that case, when a phosphor emitting fluorescence in a relation of complementary color to the wavelength of the fluorescence emitted by the first phosphor is used as the second phosphor, a white light emitting device of superior luminous efficiency can be obtained and, in addition, by appropriately designing the combination of first and second phosphors, a light emitting device emitting light of incandescent lamp color with high luminous efficiency can also be obtained. Preferably, in the light emitting device of the present invention, the first phosphor is represented by the composition formula M₁₋ₓCeₓAl(Si_{y1-z}Al_{z})N_{y2-z}O_{z}, where M represents at least one element selected from the group consisting of La, Pr, Nd, Sm, Eu, Gd, Tb, Dy, Ho, Er, Tm, Yb and Lu, x is a real number satisfying 0.1≦x≦1, y1 is a real number satisfying 5.9≦y1≦6.1, y2 is a real number satisfying 10.0≦y2 ≦10.7, and z is a real number satisfying 0.8≦z≦1.2 and further, 0.9≦z≦1.1. With such a phosphor, a light emitting device of higher luminous efficiency can be obtained.

Preferably, the peak emission wavelength of the first phosphor is at least 450 nm and at most 510 nm. Then, the first phosphor satisfactory emits light of blue to blue-green, and a light emitting device having good luminous efficiency can be obtained.

Further, preferably, the full width at half maximum of emission spectrum of the first phosphor is at least 80 nm. In that case, as the full width at half maximum of emission spectrum of the first phosphor is wide, a light emitting device having higher color rendering property and emitting more natural light can be obtained when phosphors in a relation of complementing wavelength in visible range with each other, particularly phosphors emitting light of complementary colors, are used as a combination of the first and second phosphors.

In the first phosphor, preferably, the emitted light has chromaticity coordinate x of at least 0.05 and at most 0.25 and chromaticity coordinate y of at least 0.02 and at most 0.38. Then, the first phosphor satisfactorily emits light of blue to blue-green.

As the first phosphor used in the light emitting device of the present invention, that is, the phosphor of blue to blue-green, an oxynitride phosphor (particularly, silicon, aluminum, oxygen, nitrogen and lanthanoid-based rare-earth element as an emission center), specifically a JEM phase phosphor with Ce³⁺activation represented by the composition formula La₁₋ₓCeₓAl(Si_{6-z}Al_{z})N_{10-z}O_{z} is preferably used.

Through the study of JEM phase phosphor having superior emission characteristics in the blue to blue-green region, the inventors have found that when the value x (that is, the amount of Ce activation) in each of the composition formulae described above for the JEM phase phosphor is varied, a good phosphor having peak emission wavelength in the blue to blue-green region, wide full width at half maximum of emission spectrum and high luminous efficiency can be obtained.

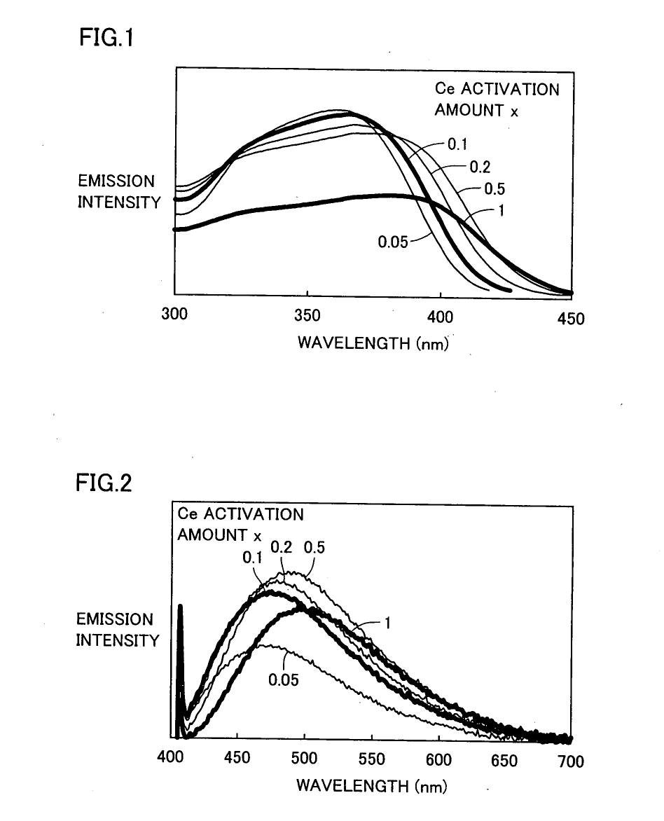

FIG. 1 shows excitation spectra of the JEM phase phosphor represented by the composition formula La₁₋ₓCeₓAl(Si_{6-z}Al_{z})N_{10-z}O_{z}, when the value x of composition formula is varied (that is, intensity of fluorescence with the wavelength of excitation light varied). By way of example, it can be seen that when the value x of the composition formula is 0.5, excitation spectrum intensity becomes high around the wavelength of 380 nm. The reason for this may be that absorption by Ce³⁺ions as the emission center intensifies in this wavelength region. FIG. 2 shows the result of measurement of emission spectra of the JEM phase phosphor represented by the composition formula La₁₋ₓCeₓAl(Si_{6-z}Al_{z})N_{10-z}O_{z}, when the value x of composition formula is varied. Here, light having the wavelength of 405 nm is used as the excitation light. The inventors have found through study that by increasing the value x in the composition formula, the peak emission wavelength varies in the wavelength region from blue to blue-green. Specifically, when x=1 in the composition formula above, the emission peak wavelength is 505 nm and full width at half maximum of emission spectrum is about 120 nm. As the full width at half maximum of emission spectrum is very wide, yellow component (wavelength of 565 nm to 600 nm) and red component (wavelength of at least 600 nm) are also included. Therefore, by using another phosphor simply to adjust some deviation from white, white light can be obtained.

The emission intensifies as the value x in the formula, that is, the amount of Ce activation, increases. Therefore, preferable value of x is at least 0.1 and at most 1.0. Further, from the foregoing, it can be understood that La contained with the composition ratio of 1-x hardly contributes to emission, and that La can be replaced with a lanthanoid-based element, specifically, at least one element selected from the group consisting of La, Pr, Nd, Sm, Eu, Gd, Tb, Dy, Ho, Er, Tm, Yb and Lu.

As an example of the JEM phase phosphor, blue phosphors such as shown in Table 2 may preferably be used.

In blue phosphors (a) to (d) shown in Table 2, atom concentration of La and atom concentration of Ce are both 2.75%, and the total atom concentration of these is 5.5%. In the composition formula, x=0.5. Further, the value z representing composition condition that allows stable formation of JEM phase phosphor is z=1.05. When the value z is at least 0.8 and at most 1.2, the JEM phase can be obtained under common manufacturing conditions, and when it is at least 0.9 and at most 1.1, the JEM phase can be obtained relatively easily, regardless of the manufacturing conditions.

In the present invention, in the composition formula La₁₋ₓCeₓAl(Si_{6-z}Al_{z})N_{10-z}O_{z} above, the value x may be x=1.0, that is, the atom concentration of La may be set to 0%, and Ce atom concentration may be set to 5.5%. Alternatively, considering stable formation of the JEM phase, the value z may be set to z=0.95 in the composition formula.

The blue phosphors (a) to (d) shown in Table 2 may be manufactured, by way of example, in the following manner. Silicon nitride powder having average grain diameter of 0.5 p.m, oxygen content of 0.93 mass % and cc type content of 92%, aluminum nitride powder, lanthanum oxide powder and cerium oxide powder are weighed and mixed to attain the ratio (mass %) of 48.374, 16.96, 16.83 and 17.8%, respectively. The mixed powder is put in a crucible of boron nitride, and the crucible is introduced to a graphite resistance heating type electric furnace.

The electric furnace is evacuated by a vacuum pump, and heated from room temperature to 800° C. Here, nitrogen gas of 99.999 vol % purity is introduced and the pressure is set to 1 MPa. Then, the temperature is increased at a rate of about 500° C./hour to the sintering temperature, and kept for a prescribed sintering time, for sintering. After sintering, the temperature is lowered to the room temperature, and the phosphor is taken out.

Table 2 shows result of sintering of blue phosphors (a) to (d) under four different sintering conditions, using the mixed powder obtained in the manner described above,

Here, it is confirmed that the JEM phase phosphor can be obtained when the pressure of nitrogen in the electric furnace is at least 0.5 MPa.

TABLE 2

| | | | Optical | Optical | Optical | Optical | Optical | |
|---|---|---|---|---|---|---|---|---|
| | | | Absorption | Absorption | Absorption | Absorption | Absorption | Ratio |
| | Sintering | Sintering | (wavelength | (wavelength | (wavelength | (wavelength | (wavelength | of JEM |
| | Temp. | Time | 400 nm) | 500 nm) | 540 nm) | 590 nm) | 650 nm) | phase |
| Blue | 1700° C. | 30 h | 0.882 | 0.18 | 0.152 | 0.129 | 0.108 | 0.92 |
| phosphor | | | | | | | | |
| (a) | | | | | | | | |
| Blue | 1800° C. | 10 h | 0.814 | 0.271 | 0.237 | 0.208 | 0.19 | 0.88 |
| phosphor | | | | | | | | |
| (b) | | | | | | | | |
| Blue | 1700° C. | 50 h | 0.872 | 0.319 | 0.295 | 0.275 | 0.26 | 0.81 |
| phosphor | | | | | | | | |
| (c) | | | | | | | | |
| Blue | 1800° C. | 30 h | 0.817 | 0.37 | 0.349 | 0.331 | 0.314 | 0.76 |
| phosphor | | | | | | | | |
| (d) | | | | | | | | |

The JEM phase ratio in the crystal phase of the sintered bodies sintered in the above-described manner was found through X-ray diffraction and diffraction peak identification as described in the pamphlet of International Publication WO2005/019376, and it was confirmed that the JEM phase was the main component occupying at least 50%. The ratio of JEM phase to the whole composition including the glass phase is not identified.

Next, total luminous flux emission spectrum measurement and optical absorption spectrum measurement were performed on the phosphor powder of blue phosphors (a) to (d), using an integrating sphere (Reference: Kazuaki OHKUBO et. al., “Absolute Fluorescent Quantum Efficiency of NBS Phosphor Standard Samples,” Journal of the Illuminating Engineering Institute of Japan, Vol. 83, No. 2, 1999, pp. 87-93). The optical absorption is calculated by first calculating reflectance of phosphor powder pressed onto a cell of 2 mm in thickness using the integrating sphere, and then by subtracting the calculated reflectance from 1.

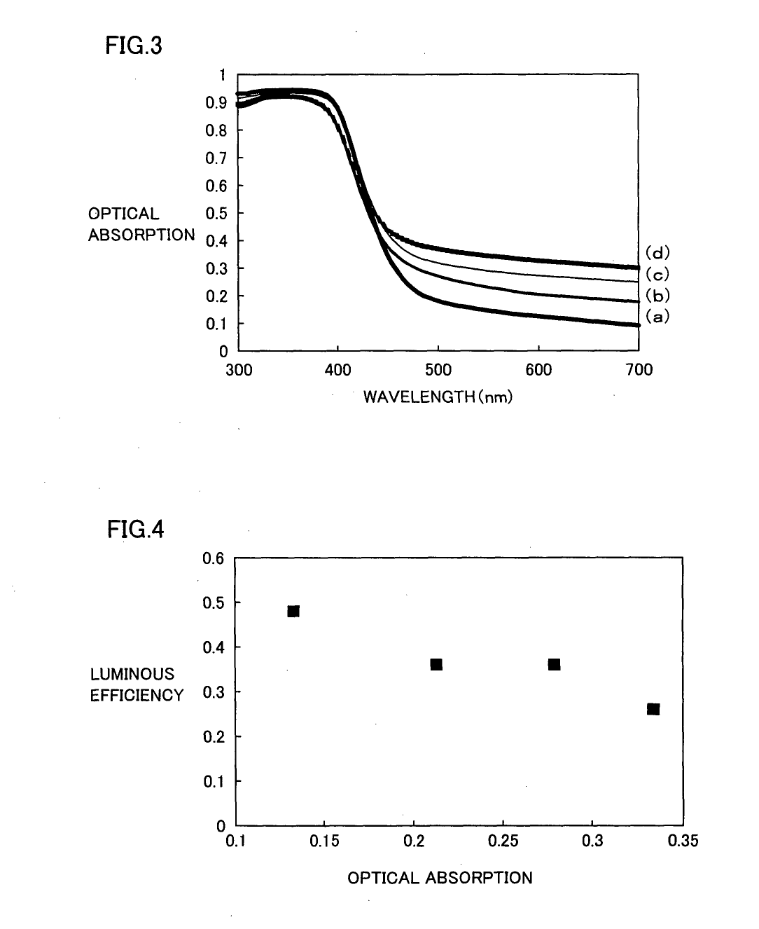

Blue phosphors (a) to (d) had peak emission wavelength of 490 nm. FIG. 3 shows wavelength dependency of optical absorption of blue JEM phase phosphor powder of blue phosphors (a) to (d). The optical absorption significantly decreases with the wavelength around and exceeding 400 nm, in each sample. It is considered that optical absorption at a wavelength shorter than 400 nm comes from absorption by the rare-earth element activated in the JEM phase phosphor, and in blue phosphors (a) to (d), comes from absorption by Ce³⁺. Each of blue phosphors (a) to (d) attains high optical absorption of 80% or more with the wavelength of 400 nm. On the other hand, optical absorption at a wavelength longer than 500 nm considerably differs among blue phosphors (a) to (d).

As described above, peak emission wavelength of blue phosphors (a) to (d) is 490 nm, and therefore, the wavelength longer than the peak emission wavelength and in the relation of complementary color to the wavelength is in the range of 580 to 600 nm.

From the result shown in Table 2, it can be seen that among blue phosphors (a) to (d), phosphors (a) to (c) have optical absorption of 30% or lower at 590 nm, that is, within the range of complementary color wavelength, while blue phosphor (d) has optical absorption at 590 nm higher than 30%.

FIG. 4 shows a relation between the optical absorption at the wavelength of 590 nm of blue phosphors (a) to (d) described above as the JEM phase phosphors, and the luminous effᵢ ciency (=quantum efficiency×excitation light absorption) of the phosphors. As can be seen, when the JEM phase phosphor has lower optical absorption at the wavelength of 590 nm, higher luminous efficiency can be attained. In order to provide a phosphor having higher luminous efficiency than competing phosphors, the inventors consider the luminous efficiency of at least 0.3 and preferably at least 0.4 is necessary. Accordingly, the optical absorption at the wavelength of 590 nm (yellow) is preferably at most 30%, more preferably at most 20% and most preferably at most 15%. The reason for this is as follows. When the content of JEM phase as the crystal phase lowers, the JEM phase having high luminous efficiency decreases and, in addition, glass phase as a noncrystalline phase increases as it is formed as a byproduct when phosphor crystal of JEM phase or the like is formed by sintering, and the glass phase has high optical absorption.

Further, when optical absorption in the visible range increases, in addition to the above-described phenomenon of luminous efficiency decrease, a phenomenon occurs that light emitted from a phosphor emitting fluorescence of long wavelength such as green, yellow or red usable in combination with the blue phosphor is absorbed. Absorption of light of other wavelength as such decreases the overall luminous efficiency of the light emitting device using a plurality of phosphors. Therefore, as can be seen from FIG. 5 showing the luminous intensity of the light emitting device when the driving current driving the semiconductor light emitting element in the light emitting device is 40 mA and the optical absorption of the phosphor, the luminous intensity of the light emitting device has higher dependency on the optical absorption (as will be described with reference to Example 1).

Further, as the ratio of glass phase in the phosphor varies lot by lot of manufacturing, the optical absorption also varies lot by lot. As a result, emission balance between the JEM phase phosphor and other phosphor varies. Consequently, color tone control of the light emitting device becomes very difficult. Such color tone variation, however, can be suppressed by maintaining the optical absorption at a prescribed value or lower.

The inventors consider that the JEM phase phosphor that does not much absorb light in the visible range, that is, JEM phase phosphor having low glass phase content, can be obtained mainly by suppressing elimination of nitrogen from the JEM phase as a crystal phase during sintering of the phosphor. Therefore, as the conditions for sintering the JEM phase phosphor, nitrogen pressure is preferably set to at least 0.5 MPa and more preferably to 1.0 MPa or higher. In order to simply improve crystal characteristics of the JEM phase, sintering at a high temperature for a long time is desired. The inventors have found, however, that the ratio of glass phase increases when the temperature is too high or the time of holding at the high temperature is too long. From the foregoing, the sintering temperature is desirably at least 1600° C. and at most 1900° C., and more desirably at least 1700° C. and at most 1800° C. Further, the sintering time is desirably at most 50 hours and more desirably at most 30 hours. Whether the oxynitride phosphor obtained through sintering comes to have the JEM phase or glass phase is not much influenced by the rare-earth element as the activator (specifically, the rare-earth element is small in amount and is positioned at the same lattice location), and therefore, the manufacturing conditions are generally applicable to JEM phase phosphors having different activation amount of rare-earth element such as La or Ce.

It is noted that in the composition formula La₁₋ₓCeₓAl(Si_{y1-z}Al_{z})N_{y2-z}O_{z} of the JEM phase phosphor, in an ideal JEM phase, it is expected that y1 and y2 are y1=6 and y2=10, respectively. Actually, however, glass phase or other crystal phase might be mixed, and therefore the result of composition analysis has some deviation from the expected values. For example, Y1 is about 5.9 to about 6.1 and y2 is about 10.0 to about 10.7.

(Second Phosphor)

In the light emitting device of the present invention, as the second phosphor to be used in combination with the first phosphor, a yellow phosphor, a red phosphor, a green phosphor or the like may be used. Though the second phosphor may include one type or a plurality of different types of phosphors, one main type phosphor is designed such that the first phosphor has the optical absorption of at most 30% at the emission peak wavelength of the fluorescence emitted by the one main type.

Preferably, the peak emission wavelength of the one main type of the second phosphor is at least 565 nm and at most 605 nm. Then, the second phosphor emits yellow fluorescence, and when used in combination with the first phosphor emitting fluorescence of blue to blue-green, white emission can be attained.

Preferably, the full width at half maximum of emission spectrum of the one main type of second phosphor is at least 80 nm. Because of the wide full width at half maximum of emission spectrum, good color rendering property can be attained.

Preferably, the second phosphor includes an oxynitride phosphor. Using an oxynitride phosphor, a phosphor having desired peak emission wavelength and wide full width at half maximum of emission spectrum can be obtained.

As the second phosphor of the present invention, by way of example, one including an Eu activated α SiAlON phosphor is preferably used. The Eu activated α SiAlON phosphor is particularly suitable as a yellow phosphor having high emission intensity and wide full width at half maximum of emission spectrum.

Specifically, an Eu activated α SiAlON phosphor including Li is preferred, as a yellow phosphor having high emission intensity and wide full width at half maximum of emission spectrum.

Typically, one including an Eu activated α SiAlON represented by a composition formula Li_{0.87m}Si₁₂₋ₘ₋ₙAlₘ₊ₙOₙN₁₆₋ₙ(1.5≦m≦2.5, n=0.5m) is preferably used.

When the second phosphor of the present invention includes an oxynitride phosphor, one including an Eu activated βSiAlON phosphor may preferably be used. The Eu activated βSiAlON phosphor can provide, as a green phosphor, good emission intensity and wide full width at half maximum of emission spectrum.

Preferably, the second phosphor of the present invention includes a nitride phosphor. The nitride phosphor can provide, as a red phosphor, good emission intensity and wide full width at half maximum of emission spectrum. For example, a phosphor including Eu activated CaAlSiN₃ is preferred as it has high emission intensity and wide full width at half maximum of emission spectrum.

In the following, specific examples of yellow, red and green phosphors as the second phosphors will be described.

(Yellow Phosphor)

As a yellow phosphor, an α SiAlON phosphor represented by a composition formula Ca_{0.93}Eu_{0.07}Si₉Al₃ON₁₅, an α SiAlON phosphor represented by a composition formula (Ca_{0.93}Eu_{0.07})_{0.25}Si_{11.25}Al_{0.75}ON_{15:75}, or an Eu activated α SiAlON phosphor represented by a composition formula Li_{0.87m}Si₁₂₋ₘ₋ₙAlₘ₊ₙOₙN₁₆₋ₙ(m=2.0, n=0.5m), as an oxynitride phosphor (particularly, one including silicon, aluminum, oxygen, nitrogen and lanthanoid based rare-earth element as an emission center) is preferably used.

The α SiAlON phosphor represented by the composition formula Ca_{0.93}Eu_{0.07}Si₉Al₃ON₁₅ has peak emission wavelength of 590 nm and full width at half maximum of emission spectrum as wide as 90 nm or wider. The α SiAlON phosphor represented by the composition formula (Ca_{0.93}Eu_{0.07})_{0.25}Si_{11.25}Al_{0.75}ON_{15.75} has peak emission wavelength of 580 nm and wide full width at half maximum of emission spectrum of about 90 nm. The Eu activated α SiAlON phosphor represented by the composition formula Li_{0.87m}Si₁₂₋ₘ₋ₙAlₘ₊ₙOₙN₁₆₋ₙ(m=2.0, n=0.5) has short peak emission wavelength of 573 to 577 nm and full width at half maximum of emission spectrum as wide as 90 nm or wider.

As shown in FIG. 20, the Eu activated yellow phosphor represented by the composition formula Li_{0.87m}Si₁₂₋ₘ₋ₙAlₘ₊ₙOₙN₁₆₋ₙ is known to have high luminous efficiency when 1.5≦m≦2.5, and therefore, a phosphor represented by the composition formula Li_{0.87m}Si₁₂₋ₘ₋ₙAlₘ₊ₙOₙN₁₆₋ₙ (1.5≦m≦2.5, n=0.5m) can be used. Further, in order to cover wider yellow wavelength range, a mixture or mixed crystal of the phosphor and one having the composition represented by the formula Ca_{0.93}Eu_{0.07}Si₉Al₃ON₁₅ or a similar composition may be used.

The excitation spectra of phosphors mentioned above all have high peak in the excitation light region of ultraviolet to violet.

The α SiAlON phosphor represented by the composition formula Ca_{0.93}Eu_{0.07}Si₉Al₃ON₁₅, or the α SiAlON represented by the composition formula (Ca_{0.93}Eu_{0.07})_{0.25}Si_{11.25}Al_{0.75}ON_{15.75} is produced in the following manner. Silicon nitride, aluminum nitride, calcium carbonate and europium oxide powder are mixed, put in a crucible of boron nitride, and after reaction in nitrogen with 1 MPa, at 1800° C. for 10 hours, the resulting body is grounded. Thus, an Eu activated α SiAlON emitting yellow light is produced.

In the present invention, as the second phosphor, a red phosphor may be used by itself or in combination with the yellow phosphor described above. As the red phosphor, one having the peak emission wavelength of about 610 to about 670 nm may preferably be used, and when combined with the first phosphor emitting fluorescence of blue to blue-green, white emission can be attained.

(Red Phosphor)

As the red phosphor, CaAlSiN₃:Eu³⁺(Eu activation amount 0.8%) as described in “Red phosphors for warm white light-emitting diodes”, Proceedings of 305th Conference of Phosphor Research Society, 2004, pp. 37-47, as a nitride phosphor (particularly, one including silicon, aluminum, nitrogen and lanthanoid based rare-earth element as an emission center) can be used. The phosphor is produced in the following manner. Silicon nitride, aluminum nitride, calcium carbonate and europium oxide powder are mixed in a glove box sealed against air and moisture, then put in a crucible of boron nitride, and after reaction in nitrogen with 1 MPa, at 1800° C., the resulting body is grounded. Thus, Eu activated CaAlSiN₃ phosphor emitting red light is produced.

The red phosphor formed of CaAlSiN₃:Eu³⁺described above has peak emission wavelength of about 650 nm and full width at half maximum of emission spectrum as wide as about 90 nm or wider.

(Green Phosphor)

In the light emitting device of the present invention, a green phosphor can also be preferably used as the second phosphor. The green phosphor should preferably be used in combination with the yellow phosphor and/or red phosphor. By such combination, light closer to natural light can be emitted. Preferable peak emission wavelength of the green phosphor is at least 510 nm and at most 565 nm, and more preferable wavelength is at least 520 nm and at most 550 nm.

As the green phosphor, an Eu activated β SiAlON as an oxynitride phosphor (particularly, one including silicon, aluminum, oxygen, nitrogen and lanthanoid based rare-earth element as an emission center) as described in “Characterization and properties of green-emitting β-SiAlON: Eu²⁺powder phosphors for white light-emitting diodes,” Applied Physics Letters 86, 211905 (2005) may be used. This is produced in the following manner. Silicon nitride, aluminum nitride and europium oxide powder are mixed, put in a crucible of boron nitride, and after reaction in nitrogen with 1 MPa, at 1900° C., the resulting body is grounded. Thus, Eu activated β SiAlON phosphor emitting green light is produced.

The green phosphor of Eu activated β SiAlON emits light of high intensity having the peak emission wavelength of about 540 nm, excited by ultraviolet to violet excitation light. The full width at half maximum of emission spectrum of the phosphor is about 55 nm.

(Light Emitting Device)

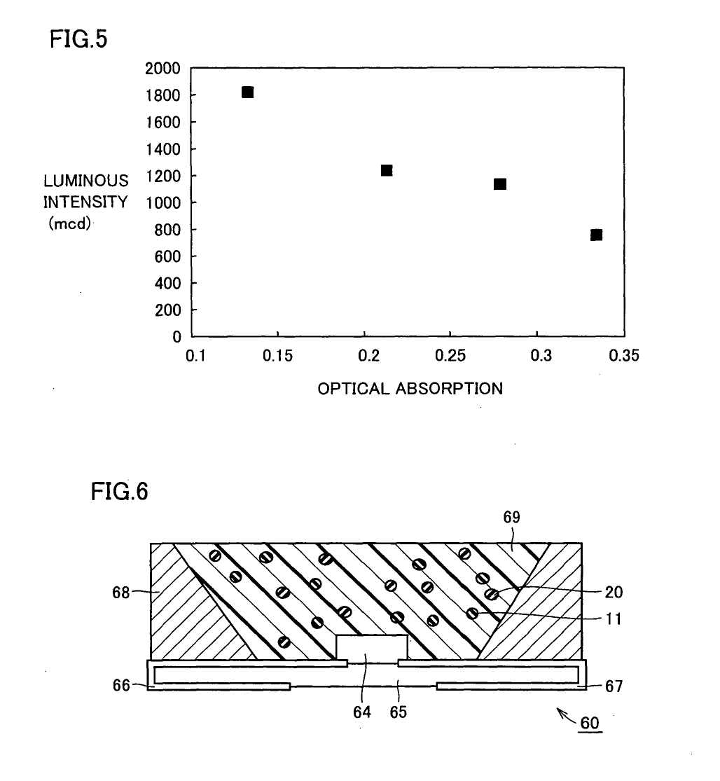

The light emitting device in accordance with the present invention will be described with reference to a cross-sectional view of a light emitting device 60 of Example 1 shown in FIG. 6.

The light emitting device 60 includes a base 65, electrodes 66 and 67 formed on a surface of base 65, a semiconductor light emitting element 64 electrically connected to electrodes 66 and 67, silicone resin 69 sealing semiconductor light emitting element 64, blue phosphor 11 and yellow phosphor 20 dispersed in silicone resin 69, and a frame 68 limiting the scope of pouring of silicone resin 69 and having a mirror-finished surface in contact with silicone resin 69 for effectively taking out the light. Electrodes 66 and 67 are drawn three-dimensionally from the upper surface of base 65 to the lower surface as a mounting surface. In light emitting device 60, blue phosphor 11 is formed as the first phosphor and yellow phosphor 20 is formed as the second phosphor, of the present invention.

Further, emission peak wavelength of the JEM phase phosphor used as the first phosphor and emission peak wavelength of the Eu activated α SiAlON used as the second phosphor of the present invention can be controlled in wide ranges while maintaining high luminous efficiency, by varying composition ratio of materials. Utilizing this characteristic, it is possible to freely design light emitting devices having various white color tones, including daylight of high color temperature to incandescent lamp color of low color temperature, particularly, light emitting devices emitting white light having the chromaticity coordinate x of at least 0.22 and at most 0.44 and chromaticity coordinate y of at least 0.22 and at most 0.44, or incandescent lamp color having the chromaticity coordinate x of at least 0.36 and at most 0.5 and chromaticity coordinate y of at least 0.33 and at most 0.46, by adjusting not only the mixture ratio but also the composition ratio of phosphors.

When the blue phosphor (a) shown in Table 2, which is a JEM phase phosphor, is used as blue phosphor 11, the peak emission wavelength is about 490 nm, and the full width at half maximum of emission spectrum is as wide as about 120 nm. Therefore, the JEM phase phosphor is very useful in fabricating a light emitting device having superior color rendering property. Conventionally, in a light emitting device using ultraviolet to violet excitation light, it has been a common practice to combine three phosphors of blue, green and red (Japanese Patent Laying Open No. 2002-171000). The reason for this is that though the conventional blue phosphor has relatively high luminous efficiency, peak emission wavelength thereof is about 450 nm and relatively short, and the full width at half maximum of emission spectrum is also narrow.

When the blue phosphor (a) as a JEM phase phosphor mentioned above is used as blue phosphor 11, the peak emission wavelength is about 490 nm, and the full width at half maximum of emission spectrum is as wide as about 120 nm, and therefore, only by this phosphor, the visible range can widely be covered. Further, simply by combining yellow phosphor 20 only, which is a complementary color to blue, to attain white, a white light emitting device with superior color rendering property can be realized. Here, as the yellow phosphor 20, one having peak emission wavelength of 565 nm to 605 nm is desired to attain white light by the combination with the blue phosphor, and having full width at half maximum of emission spectrum as wide as 80 nm or wider is desired to improve color rendering property. Further, it is desired that the yellow phosphor emits light with high efficiency, by the same excitation light as for blue phosphor, that is, ultraviolet to violet excitation light.

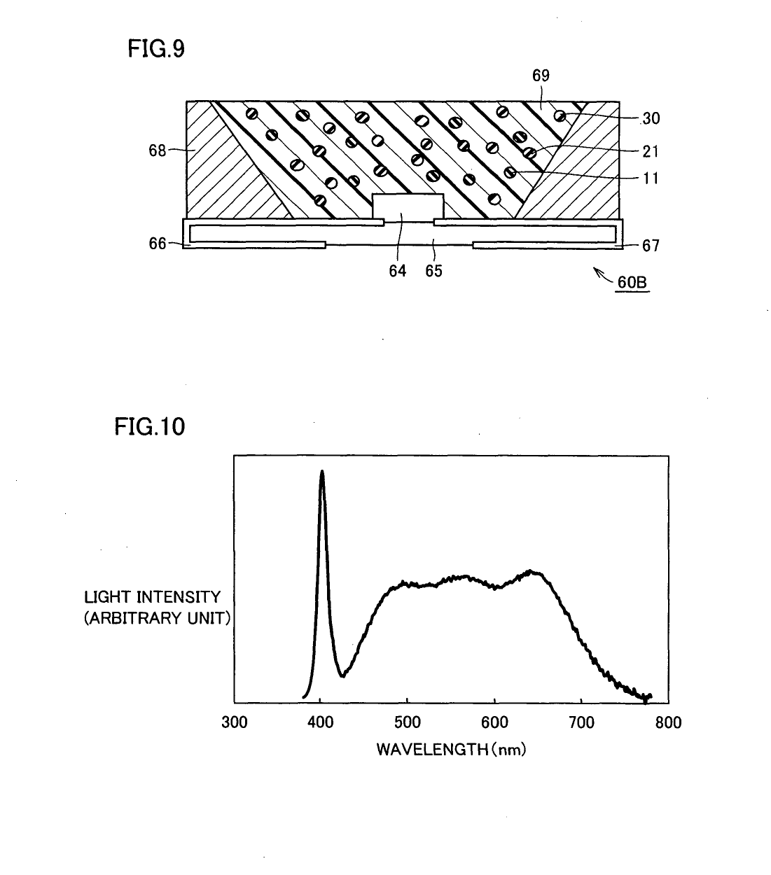

Other than the above-described light emitting device including a combination of blue and yellow phosphors, white light emission can be attained by appropriately combining and sealing in silicone resin phosphors of blue, blue-violet, yellow, red and green. By way of example, referring to FIG. 9 showing a cross-sectional view of a light emitting device of Example 2, which will be described later, white light emission can be attained also by combining blue phosphor 11, yellow phosphor 21 and red phosphor 30. Here, blue phosphor 11 is formed as the first phosphor, and yellow phosphor 21 and red phosphor 30 are formed as the second phosphor, of the present invention, respectively.

In the light emitting device in accordance with the present invention, the semiconductor light emitting element, a second member having the second phosphor dispersed therein and a first member having the first phosphor dispersed therein may be arranged in this order.

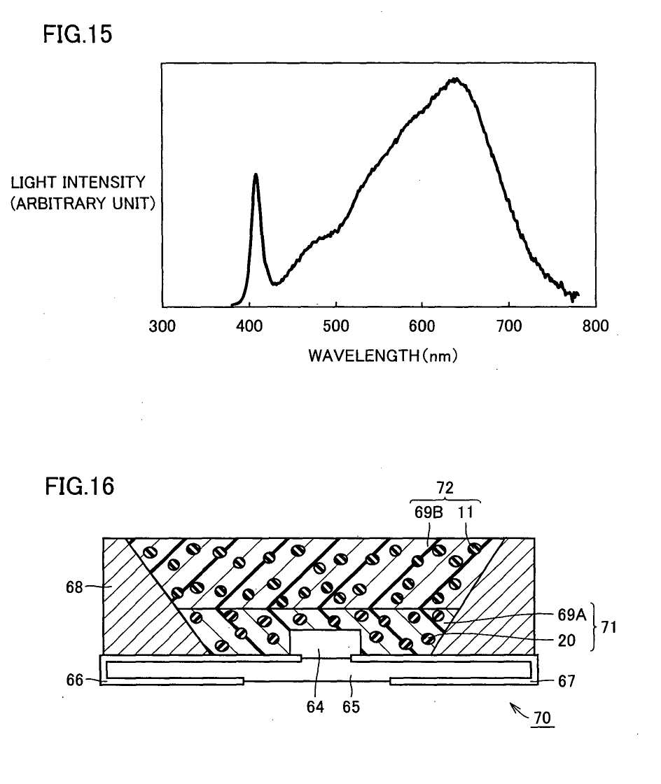

Specifically, the light emitting device may have a structure of light emitting device 70 in which layers of resin members having phosphors dispersed therein are separated phosphor by phosphor, as shown in the cross-sectional view of FIG. 16 of the light emitting device in accordance with Example 6.

Light emitting device 70 includes a base 65, electrodes 66 and 67 formed on the surface thereof, the above-described semiconductor light emitting element 64 electrically connected to electrodes 66 and 67, a long wavelength phosphor member 71 (formed of silicone resin 69A and yellow phosphor 20 (α SiAlON phosphor) dispersed in the silicone resin 69A) sealing semiconductor light emitting element 64, a blue phosphor member 72 (formed of silicone resin 69B and blue phosphor 11 (JEM phase phosphor) dispersed in the silicone resin 69B) formed to cover long wavelength phosphor member 71, and a frame 68 limiting the scope of pouring of silicone resin 69A and 69B and having a mirror-finished surface in contact with the silicone resin for effectively taking out the light. Here, the long wavelength phosphor member 71 is formed as the second member and the blue phosphor member 72 is formed as the first member, respectively, of the present invention.

Though yellow phosphor 20 is dispersed in long wavelength phosphor member 71 in the example of FIG. 16, red phosphor or green phosphor emitting color of longer wavelength than blue may be dispersed. Alternatively, one or more of other green, yellow and red phosphors may be dispersed in combination.

In the present invention, the second member may further include a plurality of members, and in each of the plurality of members, the second phosphor of different types may be dispersed. Specifically, blue phosphor member 72 and long wavelength phosphor member 71 may not be two layers, and long wavelength phosphor member 71 may be divided into multiple layers, in which different phosphor materials may be dispersed. By way of example, the long wavelength phosphor member may be divided into two layers, and the layer closer to semiconductor light emitting element 64 may include red phosphor dispersed therein and the other layer may include yellow phosphor dispersed therein. Alternatively, the long wavelength phosphor member may be divided into three layers, the layer closest to semiconductor light emitting element 64 may include red phosphor dispersed therein, the layer second closest may include yellow phosphor dispersed therein and the farthest layer may include green phosphor dispersed therein.

(Semiconductor Light Emitting Element)

Turning to the example shown in FIG. 6, as semiconductor light emitting element 64 necessary for the light emitting device 60, an LED formed of a GaN-based semiconductor (typically, a semiconductor containing at least Ga and N, and using Al, In and n-type dopant or p-type dopant as needed) and having an activation layer of InGaN material may be used.

As to the emission wavelength of the excitation light for the semiconductor light emitting element, emission peak wavelength of at least 350 nm covering the peak wavelength of excitation spectrum for the JEM phase phosphor is desired. Particularly, emission peak wavelength of at least 390 nm and at most 420 nm that attains satisfactory electric/optical conversion efficiency in an InGaN semiconductor light emitting element preferably used as the semiconductor light emitting element is desired. In the examples described in the following, an LED having emission peak wavelength of at least 405 nm is used as the semiconductor light emitting element. Further, in the present invention, a semiconductor light emitting element having a p-type electrode and an n-type electrode on one surface may be used.

### EXAMPLES

In Examples below, the following method of measurement was used.

Emission peak wavelength, full width at half maximum of emission spectrum, and excitation spectrum

Using an integrating sphere, total luminous flux emission spectrum and optical absorption spectrum of phosphor powder were measured (Reference: Kazuaki OHKUBO et. al., “Absolute Fluorescent Quantum Efficiency of NBS Phosphor Standard Samples,” Journal of the Illuminating Engineering Institute of Japan, Vol. 83, No. 2, 1999, pp. 87-93). For the Measurement, spectrophotometer type F4500 (manufactured by HITACHI) was used. The optical absorption was calculated by first calculating reflectance of phosphor powder pressed onto a cell of 2 mm in thickness using the integrating sphere, and then by subtracting the calculated reflectance from 1.

Phosphor Chromaticity Variation

Using spectral measurement apparatus MCPD7000 (manufactured by Otsuka Electronics Co. Ltd.), chromaticity coordinates were measured, and chromaticity variation from 0° C. to 100° C. was evaluated.

### Example 1

Next, light emitting device 60 of Example 1 will be described with reference to a cross-sectional view of FIG. 6.

The light emitting device 60 includes a base 65, electrodes 66 and 67 formed on a surface of base 65, a semiconductor light emitting element 64 electrically connected to electrodes 66 and 67, silicone resin 69 sealing semiconductor light emitting element 64, blue phosphor 11 and yellow phosphor 20 dispersed in silicone resin 69, and a frame 68 limiting the scope of pouring of silicone resin 69 and having a mirror-finished surface in contact with silicone resin 69 for effectively taking out the light. Electrodes 66 and 67 are drawn three-dimensionally from the upper surface of base 65 to the lower surface as a mounting surface. Here, blue phosphor 11 is formed as the first phosphor and yellow phosphor 20 is formed as the second phosphor, of the present invention.

As blue phosphor 11, the above-described blue phosphor (a) was used, and as yellow phosphor 20, α SiAlON phosphor represented by the composition formula Ca_{0.93}Eu_{0.07}Si₉Al₃ON₁₅ was used. In order that the light emitting device emits white light, the two phosphors were dispersed in silicone resin 69 with the mixture ratio (mass ratio) of to 20:6.

Blue phosphor 11 as the JEM phase phosphor has as small an optical absorption as 0.129 at the wavelength of 590 nm (yellow), and therefore, the fluorescence emitted from the combined yellow phosphor 20 is not much absorbed, and blue phosphor 11 itself has high luminous efficiency. As a result, the light emitting device attained the luminous intensity of 1820 milli candela, when the semiconductor light emitting element 64 was driven with the driving current of 40 mA, as shown in FIG. 5.

The inventors studied various phosphors and have found that the Eu activated a SiAlON phosphor used in the present example satisfies the necessary conditions and is a suitable phosphor. Particularly, in the present example, yellow phosphor 20 consisting of α SiAlON phosphor represented by the composition formula Ca_{0.93}Eu_{0.07}Si₉Al₃ON₁₅ was used. The phosphor has the characteristics that the emission peak wavelength is about 590 nm, and full width at half maximum of emission spectrum is as wide as about 90 nm or wider. Further, excitation spectrum (fluorescence intensity distribution when the wavelength of excitation light is varied) has a high peak in a near ultraviolet region.

In the present example, the blue phosphor does not much absorb yellow light, the blue phosphor as the JEM phase phosphor itself has superior luminous efficiency, and in addition, only two types of phosphors are used and amount of dispersion of the phosphor particles in the resin is small, whereby high luminous intensity can be attained.

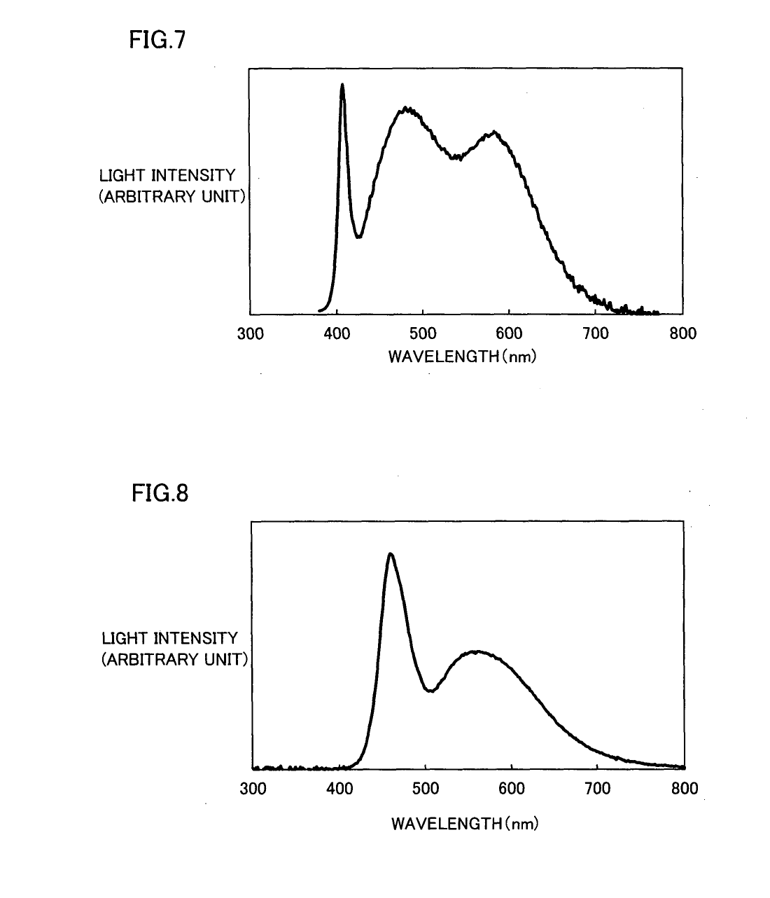

FIG. 7 shows emission spectrum of the light emitting device using the above-described two phosphors mixed. The light emitted by the light emitting device exhibited day white color having chromaticity coordinate x of x=0.32 and chromaticity coordinate y of y=0.35. The average color rendering index Ra as an indicator of natural light emission was as high as 88.

The light emitting device of the present example also has the following advantages. An LED having peak emission wavelength of 405 nm of low visibility is used as the semiconductor light emitting element, and visible light emission from the light emitting device comes only from the phosphors. Therefore, there is only a small variation in emission spectrum derived from individual differences of LEDs as the excitation source and ill-balanced emission intensity of the LED and phosphors, and as a result, stable chromaticity can be attained. Further, in the present example, phosphors having physical characteristics such as specific gravity similar to each other are used. Therefore, almost uniform dispersion of phosphors in the resin becomes possible. Consequently, variation in the direction of light emission is small and variation in the color of emission is small among light emitting devices.

Further, blue phosphor 11 and yellow phosphor 20 are both formed of one type of silicon oxynitride, that is, oxynitride phosphors, in which variation in luminous efficiency due to temperature change during driving is small. Therefore, variation in chromaticity in a wide range of driving temperature from 0° C. to 100° C. is as small as ⅙ to ¼ of a light emitting device using an oxide phosphor of Comparative Example 1 described below.

### Comparative Example 1

As an example of a conventional light emitting device, one having a combination of a blue light emitting diode and a YAG:Ce³⁺phosphor emitting yellow fluorescence by excitation light emitted from the blue light emitting diode has been known (Japanese Patent Laying-Open No. 10-163535). FIG. 8 shows an emission spectrum of the light emitting device of Comparative Example 1 having this structure. Here, the blue light emitted by the light emitting diode and the yellow emitted from the YAG:Ce³⁺phosphor are complementary to each other, and therefore, quasi white light is emitted. The blue light, however, has narrow full width at half maximum of emission spectrum and, therefore, emission intensity falls near the wavelength of 500 nm. As a result, the emission spectrum is different from natural light, and average color rendering index Ra is 84, which is lower than that of the inventive example.

### Comparative Example 2

A semiconductor light emitting device in which blue phosphor 11 of the example of the present invention was replaced by above-described blue phosphor (d) having relatively high optical absorption at longer wavelength was fabricated as Comparative Example 2. The luminous intensity was 760 milli candela (42% of Example 1) when the semiconductor light emitting element 64 was driven with the driving current of 40 mA, and the emitted light had chromaticity coordinate x of x=0.35 and chromaticity coordinate y of y=0.36. Possible reason is as follows. The optical absorption of blue phosphor (d) described above at the yellow wavelength is higher than that of blue phosphor (a), and therefore, fluorescence of yellow attenuates. Further, the luminous efficiency of blue phosphor (d) itself is lower than that of blue phosphor (a). The influences of these characteristics interact to decrease luminous intensity, and offset each other to cause variation in chromaticity. Further, five samples of light emitting devices were prepared and chromaticity variation among the samples was larger than in Example 1.

### Example 2

FIG. 9 is a cross-sectional view of a light emitting device 60B that emits more natural light. Components similar to those shown in FIG. 6 are denoted by the same reference characters, and only the phosphors differ.

In silicone resin 69, three different types of phosphors are dispersed to attain white light emission. Specifically, as blue phosphor 11, the above-described blue phosphor (a) was used, as yellow phosphor 21 mentioned above, cc SiAlON represented by the composition formula (Ca_{0.93}Eu_{0.07})_{0.25}Si_{11.25}Al_{0.75}ON_{15.75} was used, and as a red phosphor 30, a small amount of Eu activated CaAlSiN₃ was added, with the mixture ratio (mass ratio) of 20:6:2. Here, blue phosphor 11 is formed as the first phosphor, and yellow phosphor 21 and red phosphor 30 are formed as the second phosphor, respectively, of the present invention.

Red phosphor 30 used in the present example has very high luminous efficiency and, therefore, the amount of addition is set to be about 10% of the total amount of phosphors. Therefore, scattering of fluorescence or absorption of excitation light by the red phosphor was not much observed, and decrease in luminous intensity of the light emitting device was hardly recognized.

Red phosphor 30 has full width at half maximum of emission spectrum of about 95 nm, and because of emission in the red visible range that has not been sufficiently attained by blue phosphor 11 and yellow phosphor 21 only, flat emission spectrum can be attained. FIG. 10 shows the emission spectrum of the light emitting device having the above-described three phosphors mixed. The light emitted by the light emitting device was white, with chromaticity coordinate x of x=0.37 and chromaticity coordinate y of y=0.39, and luminous intensity thereof was 1520 milli candela (when semiconductor light emitting element 64 was driven with the driving current of 40 mA). As can be seen from the emission spectrum, uniform light emission was realized over the entire wavelength region of visible light, and the average color rendering index Ra as an indicator of natural light emission was as high as 96. In order to attain such a high color rendering property, it is desired that red phosphor 30 has full width at half maximum of emission spectrum as wide as 80 nm or wider. Red phosphor 30 described above had full width at half maximum of emission spectrum of 95 nm.

### Comparative Example 3

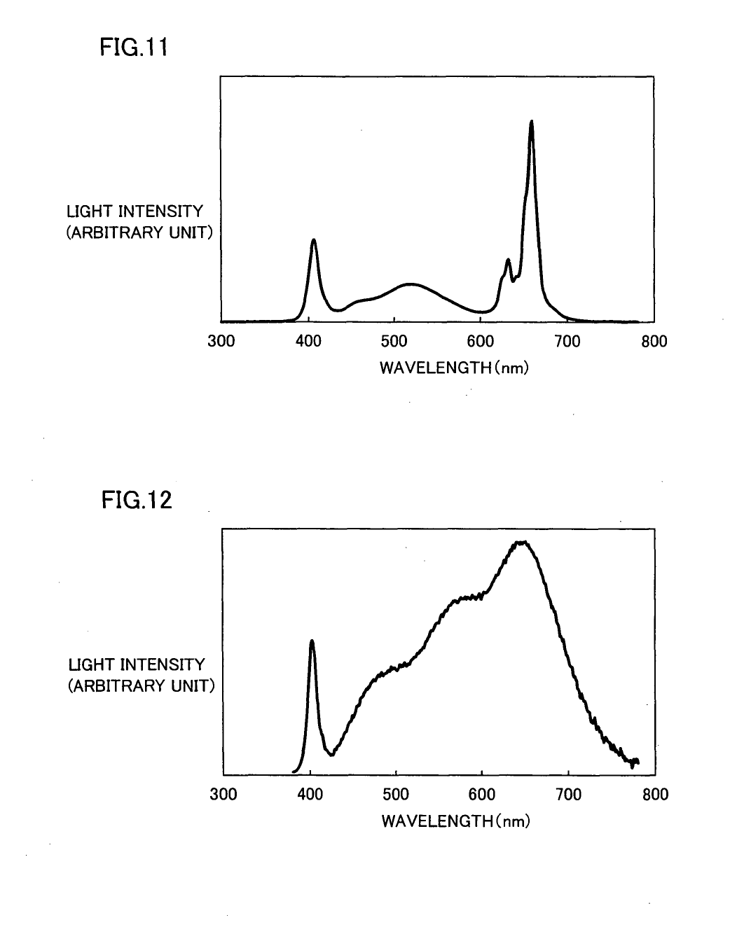

As a comparative example of the prior art using three different types of phosphors, a light emitting device was fabricated by replacing blue phosphor 11, yellow phosphor 21 and red phosphor 30 of Example 2 with a blue phosphor BaMgAl₁₀O₁₇:Eu²⁺, a green phosphor of SrAl₂O₄:Eu²⁺and a red phosphor of 0.5MgF₂·3.5MgO·GeO₂:Mn⁴⁺. The obtained emission spectrum was as shown in FIG. 11, and day white light having chromaticity coordinate x of x=0.35 and chromaticity coordinate y of y=0.37 was emitted. As can be seen also from the emission spectrum, the average color rendering index Ra was as low as 60. The luminous intensity of the light emitting device of Comparative Example 3 was 1120 milli candela (when semiconductor light emitting element 64 was driven with the driving current of 40 mA).

### Example 3

Next, using three different types of phosphors, a light emitting device of Example 3 attaining warmer, natural light emission was fabricated. Referring to FIG. 9, in the present light emitting device, the blue phosphor 11 is replaced by a blue-green phosphor, an α SiAlON phosphor represented by composition formula (Ca_{0.93}Eu_{0.07})_{0.25}Si_{11.25}Al_{0.75}ON_{15.75} is used as yellow phosphor 21, and an Eu activated CaAlSiN3 phosphor is used as red phosphor 30. Namely, simply the phosphors and mixture ratio (mass ratio) are changed.

In the present example, in the JEM phase phosphor as the first phosphor, a blue-green phosphor not containing La but having Ce composition ratio x=1 was used. Peak emission wavelength is about 505 nm, and the full width at half maximum of emission spectrum is as wide as about 120 nm, which is rare among other phosphors emitting blue to blue-green light. Therefore, the JEM phase phosphor is very useful in fabricating a light emitting device having superior color rendering property. Further, the optical absorption of blue-green phosphor was 21% at the wavelength of 580 nm and 18% at the wavelength of 650 nm, which are in the relation of complementary color to the wavelength of 505 nm as the first wavelength of the present invention.

Further, the α SiAlON phosphor represented by composition formula (Ca_{0.93}Eu_{0.07})_{0.25}Si_{1.25}Al_{0.75}ON_{15.75} as the yellow phosphor has peak emission wavelength of 580 nm and wide full width at half maximum of emission spectrum of about 90 nm.

Further, in order to have emission spectrum closer to the natural light, Eu activated CaAlSiN₃ phosphor was added as red phosphor 30. To attain light emission of warmer color, the mixture ratio (mass ratio) of blue-green phosphor, which is a replacement for the blue phosphor of Example 2, is reduced by about 50%, and the mixture ratio (mass ratio) of red phosphor was increased by about 25%. Specifically, the mixture ratio (mass ratio) among blue-green:yellow:red was set to 10:6:2.5.

FIG. 12 shows the emission spectrum of the light emitting device using the mixture of above-described three types of phosphors. The light emitted from the light emitting device had a so-called incandescent lamp color having chromaticity coordinate x of x=0.43 and chromaticity coordinate y of y=0.41. As can be seen from the emission spectrum, light having emission spectrum very close to that of standard light source A was obtained, and the average color rendering index Ra as an indicator of natural light emission was as high as 94.

Further, as the red phosphor used in the present example had very high luminous efficiency, by slightly increasing the amount of addition, emission intensity in the red region could be improved. Further, as the mixture ratio (mass ratio) of blue phosphor having relatively low visibility and relatively low luminous efficiency was decreased, the luminous intensity of the light emitting device was not decreased from that of Example 3, though the light had the emission spectrum of incandescent lamp color having lower overall luminous intensity.

### Example 4

Next, a light emitting device of Example 4 attaining more natural light emission was fabricated.

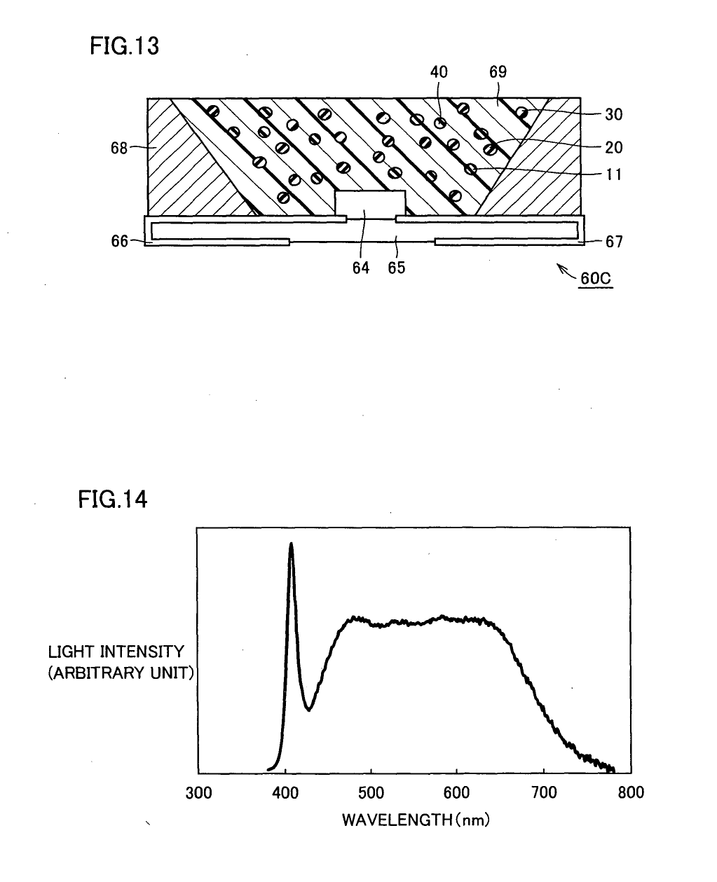

FIG. 13 is a cross-sectional view of a light emitting device 60C. Here, components similar to those of FIG. 6 are denoted by the same reference characters. In the light emitting device of the present example, four different phosphors are dispersed to attain white light emission. Specifically, as blue phosphor 11, the above-described blue phosphor (a) is used, an α SiAlON phosphor represented by composition formula Ca_{0.93}Eu_{0.07}Si₉Al₃ON₁₅ is used as yellow phosphor 20, an Eu activated CaAISiN₃ phosphor is added as red phosphor 30, and a small amount of Eu activated β SiAlON phosphor is mixed as a green phosphor 40. The mixture ratio (mass ratio) is 20:6:2:2. Here, blue phosphor 11 is formed as the first phosphor, and yellow phosphor 20, red phosphor 30 and green phosphor 40 are formed as the second phosphor, respectively, of the present invention.

Green phosphor 40 emitted light of high intensity, having the wavelength of about 540 nm, with the excitation light of ultraviolet to violet. The full width at half maximum of emission spectrum of the phosphor was about 55 nm. Green phosphor 40 is provided to fill the gap between blue phosphor 11 and yellow phosphor 20, and therefore, the full width at half maximum of at least 45 nm is sufficient. Rather, in the present example, if the full width at half maximum of green phosphor 40 were too wide, flatness of the emission spectrum would be lost as the wavelength region has high visibility, resulting in unnatural light emission. Here, desirably, emission peak wavelength of green phosphor 40 is at least 510 nm and at most 565 nm, and more desirably, at least 520 nm and at most 550 nm.

FIG. 14 shows emission spectrum of the light emitting device having the above-described four different types of phosphors. The gap of light emission in the green region, resulting from the use of the blue phosphor having emission spectrum slightly biased to the shorter wavelength side, could be covered by the green phosphor.

The light emitted from the light emitting device was white, having chromaticity coordinate x of x=0.35 and chromaticity coordinate y of y=0.37. As can be seen from the emission spectrum, uniform light emission was realized over the entire wavelength region of visible light, and the average color rendering index Ra as an indicator of natural light emission was as high as 98.

Further, the green phosphor used in the present example has very high luminous efficiency and has peak emission wavelength in the wavelength region of high visibility, and therefore, the amount of addition thereof is set to about 10% of the total amount of phosphors. Therefore, decrease in luminous intensity of the light emitting device possibly caused by increased amount of phosphor was hardly recognized, as compared with Examples 1 and 2.

### Example 5

Next, a light emitting device of Example 5 attaining warmer and natural light emission was fabricated. The cross section of the light emitting device is the same as that of Example 4 shown in FIG. 13, except that the phosphors are replaced.

In silicone resin 96, four different types of phosphors are dispersed to attain light emission of incandescent lamp color. Specifically, a blue-green phosphor used in place of blue phosphor 11, an α SiAlON phosphor represented by composition formula (Ca_{0.93}Eu_{0.07})_{0.25}Si_{11.25}Al_{0.75}ON_{15.75} used as yellow phosphor 20, an Eu activated CaAISiN₃ phosphor used as red phosphor 30, and green phosphor 40 of Eu activated β SiAlON are dispersed.

To attain light emission of warmer color, the mixture ratio (mass ratio) of blue (blue-green) phosphor was reduced by about 50% from Example 4 and the mixture ratio (mass ratio) of yellow/red phosphor was increased by about 10%. Specifically, the mixture ratio (mass ratio) among blue-green:yellow:red:green was set to 10:6.6:2.2:1.6.

FIG. 15 shows emission spectrum of the light emitting device having the above-described four phosphors mixed. The light emitted from the light emitting device was of incandescent lamp color having chromaticity coordinate x of x=0.45 and chromaticity coordinate y of y=0.42. As can be seen from the emission spectrum, light having emission spectrum very close to that of standard light source A was obtained except for the wavelength of excitation light of low visibility, and the average color rendering index Ra as an indicator of natural light emission was as high as 97.

Further, the red/yellow phosphor used in the present example had very high luminous efficiency and, therefore, by slightly increasing the amount of addition, emission intensity in the red/yellow region could be improved. Further, as the mixture ratio (mass ratio) of blue was decreased to attain the light of incandescent lamp color, decrease in luminous intensity of the light emitting device was hardly recognized as compared with Example 4, though the light was of incandescent lamp color in which the ratio of light having low visibility is higher than white.

### Example 6

Next, a light emitting device 70 in which the resin member for dispersing phosphors is divided phosphor by phosphor will be described with reference to a cross-sectional view of FIG. 16.

Light emitting device 70 includes abase 65, electrodes 66 and 67 formed on the surface thereof, the above-described semiconductor light emitting element 64 electrically connected to electrodes 66 and 67, a long wavelength phosphor member 71 (formed of silicone resin 69A and yellow phosphor 20 (α SiAlON phosphor) dispersed in the silicone resin 69A) sealing semiconductor light emitting element 64, a blue phosphor member 72 (formed of silicone resin 69B and blue phosphor 11 (JEM phase phosphor) dispersed in the silicone resin 69B) formed to cover long wavelength phosphor member 71, and a frame 68 limiting the scope of pouring of silicone resin 69A and 69B and having a mirror-finished surface in contact with the silicone resin for effectively taking out the light.

In the present example, the above-described blue phosphor (a) was used as blue phosphor 11, and an α SiAlON phosphor represented by composition formula Ca_{0.93}Eu_{0.07}Si₉Al₃ON₁₅ was used as yellow phosphor 20.

In this manner, as blue phosphor member 72 and long wavelength phosphor member 71 are separated and long wavelength phosphor member 71 is positioned closer to semiconductor light emitting device 64, yellow light of high intensity is emitted from yellow phosphor 20 arranged at a portion where the excitation light has high intensity. However, blue phosphor member 72 is positioned on the outer side, and therefore, if optical absorption of yellow is high at that portion, emission of yellow light to the outside of light emitting device would be hindered, resulting in decrease in overall luminous intensity. Therefore, when such a structure is to be adopted, it becomes more important to lower the optical absorption of yellow by the blue phosphor 11 than in Example 1 in which blue and yellow phosphors are mixed and dispersed in resin. By arranging the blue phosphor member, of which optical absorption of light having long wavelength is suppressed to a prescribed value or lower, in the manner of the present example, synergistic effect of arrangement (effect that optical absorption of blue to blue-green light by the yellow phosphor is suppressed) and decrease in optical absorption of long wavelength light (effect that optical absorption of yellow by the blue phosphor is suppressed) can be attained, so that a light emitting device having extremely high luminous efficiency could be obtained, which exhibited the luminous intensity of 2020 milli candela (when semiconductor light emitting element 64 was driven with the driving current of 40 mA).

### Example 7

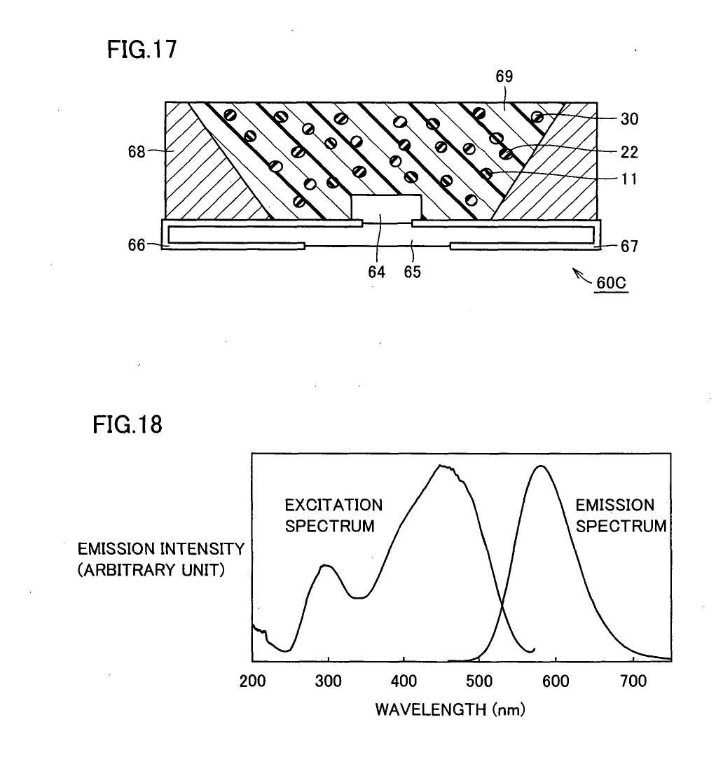

FIG. 17 is a cross-sectional view of a light emitting device 60C emitting natural, brighter light. Components similar to those of FIG. 9 are denoted by the same reference characters, and only the phosphors are different.

In silicone resin 69, three different phosphors are dispersed to attain white light emission. Specifically, mixture ratio (mass ratio) among blue:yellow:red was set to 20:6:2.

As a yellow phosphor, an Eu activated α SiAlON phosphor represented by composition formula Li_{0.87m}Si₁₂₋ₘ₋ₙAlₘ₊ₙOₙN₁₆₋ₙ(m=2.0, n=0.5m) was used. As compared with the α SiAlON phosphor represented by composition formula Ca_{0.93}Eu_{0.07}Si₉Al₃ON₁₅ used in Example 2 and other examples having peak emission at 590 nm, the phosphor of the present example has shorter peak emission wavelength of 573 to 577 nm. The phosphor has wide full width at half maximum of emission spectrum of at least 90 nm. FIG. 18 shows representative excitation and emission spectra of the phosphor. When yellow phosphor 22 is used, it becomes easier to increase luminous intensity, as the peak emission wavelength thereof is close to a region of high visibility to human eyes.

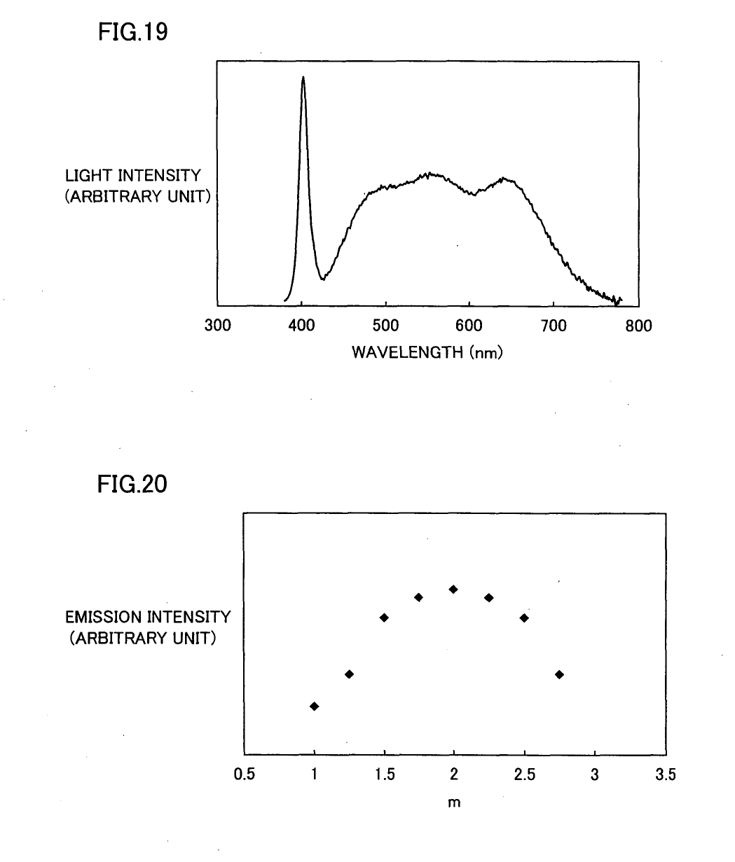

FIG. 19 shows emission spectrum of the light emitting device having the above-described three different phosphors mixed. The light emitted from the light emitting device was white, having chromaticity coordinate x of x=0.36 and chromaticity coordinate y Of y=0.39, and had the luminous intensity of 1720 milli candela (when semiconductor light emitting element 64 was driven with the driving current of 40 mA). As can be seen from the emission spectrum, uniform light emission was realized over the entire wavelength region of visible light, and the average color rendering index Ra as an indicator of natural light emission was as high as 94. Thus, it was found that use of the yellow phosphor of the present example was desirable to attain satisfactory color rendering property as well as high luminous intensity.

(Other Possibilities)

Though phosphors are dispersed in silicone resin in the examples, the resin may be a different resin such as epoxy resin, or other transparent material such as glass may be used. As for green to red phosphors, not only those described in the examples but also those of Comparative Examples may be added. Further, a phosphor or phosphors other than described above, such as a TAG(TbAl₃O₁₂) phosphor may be used.

Further, though an LED is used as the semiconductor light emitting element in the examples above, a semiconductor laser may be used. Further, the wavelength of the excitation light may be any wavelength provided that it realizes satisfactory electric/optical conversion efficiency of a semiconductor light emitting element and is near the peak wavelength of excitation spectrum of the phosphor.

Although the present invention has been described and illustrated in detail, it is clearly understood that the same is by way of illustration and example only and is not to be taken by way of limitation, the spirit and scope of the present invention being limited only by the terms of the appended claims.

1. A phosphor emitting fluorescence of a first wavelength, having optical absorption of at most 30% at a wavelength longer than said first wavelength and in a relation of complementary color to the first wavelength, and having JEM phase as a main crystal phase.

2. The phosphor according to claim 1, represented by a composition formula M₁₋ₓCeₓAl(Si_{y1-z}Al_{z})N_{y2-z}O_{z} where M represents at least one element selected from the group consisting of La, Pr, Nd, Sm, Eu, Gd, Tb, Dy, Ho, Er, Tm, Yb and Lu,
x is a real number satisfying 0.1≦x≦1,
y1 is a real number satisfying 5.9≦y1≦6.1,
y2 is a real number satisfying 10.0≦y2≦10.7, and
z is a real number satisfying 0.8≦z≦1.2.

3. A light emitting device, comprising:
a semiconductor light emitting element emitting excitation light;
a first phosphor absorbing said excitation light and emitting fluorescence of a first wavelength; and
a second phosphor of one type or a plurality of types absorbing said excitation light and emitting fluorescence of a second wavelength longer than said first wavelength
said first phosphor includes a JEM phase phosphor as a main crystal phase, the first phosphor having an optical absorption of at most 30% at a peak emission wavelength of fluorescence emitted by one main type of said second phosphor, wherein the second wavelength is in a complementary color relationship to the first wavelength.

4. (canceled)

5. The light emitting device according to claim 3, wherein said first phosphor has peak emission wavelength of at least 450 nm and at most 510 nm.

6. The light emitting device according to claim 3, wherein said first phosphor has full width at half maximum of emission spectrum of at least 80 nm.

7. The light emitting device according to claim 3, wherein light emitted from said first phosphor has chromaticity coordinate x of at least 0.05 and at most 0.25 and chromaticity coordinate y of at least 0.02 and at most 0.38.

8. The light emitting device according to claim 3, wherein one main type of said second phosphor has peak emission wavelength of at least 565 nm and at most 605 nm.

9. The light emitting device according to claim 3, wherein one main type of said second phosphor has full width at half maximum of emission spectrum of at least 80 nm.

10. The light emitting device according to claim 3, wherein said second phosphor includes an oxynitride phosphor.

11. The light emitting device according to claim 10, wherein said second phosphor includes an Eu activated α SiAlON phosphor.

12. The light emitting device according to claim 11, wherein said second phosphor includes an Eu activated α SiAlON containing Li.

13. The light emitting device according to claim 11, wherein said second phosphor includes an Eu activated α SiAlON represented by a composition formula Li_{0.87m}Si₁₂₋ₘ₋ₙAlₘ₊ₙOₙN₁₆₋ₙ(1.5≦m≦2.5, n=0.5 m.

14. The light emitting device according to claim 10, wherein said second phosphor includes an Eu activated β SiAlON phosphor.

15. The light emitting device according to claim 3, wherein said second phosphor includes a nitride phosphor.

16. The light emitting device according to claim 15, wherein said second phosphor includes an Eu activated CaAlSiN₃.

17. The light emitting device according to claim 3, wherein said semiconductor light emitting element, a second member having said second phosphor dispersed, and a first member having said first phosphor dispersed are arranged in this order.

18. The light emitting device according to claim 17, wherein said second member further includes a plurality of members, and the second phosphors of different types are dispersed respectively in said plurality of members.

19. The light emitting device according to claim 3, wherein said excitation light has peak emission wavelength of at least 350 nm and at most 420 nm.

20. The light emitting device according to claim 3, wherein emission of said light emitting device has chromaticity coordinate x of at least 0.22 and at most 0.44 and chromaticity coordinate y of at least 0.22 and at most 0.44, or emission of said light emitting device has chromaticity coordinate x of at least 0.36 and at most 0.5 and chromaticity coordinate y of at least 0.33 and at most 0.46.

21. (canceled)

22. The light emitting device of claim 3, wherein the first phosphor is represented by a composition formula M₁₋ₓCeₓAl(Si_{y1-z}Al_{z})N_{y2-z}O_{Z}, wherein
M represents at least one element comprising at least one of La, Pr, Nd, Sm, Eu, Gd, Tb, Dy, Ho, Er, Tm, Yb or Lu,
x is a real number satisfying 0.1≦x≦1,
y1 is a real number satisfying 5.9≦y1≦6.1,
y2 is a real number satisfying 10.0≦y2≦10.7, and
z is a real number satisfying 0.8≦z≦1.2.
